(19) United States
(12) Patent Application Publication
(10) Pub. No.: US 2021/0276284 A1
(43) Pub. Date: Sep. 9, 2021

(54) METHOD FOR PRODUCING A PRESSURE ACCUMULATOR

(71) Applicant: Rehau AG + Co., Rehau (DE)

(72) Inventors: Thomas Lanzl, Regensburg (DE); Peter Stadthalter, Burghaslach (DE); Stefan Spörl, Oberkotzau (DE); Stefan Horn, Geroldsgrün-Langenbach (DE); Markus Friederich, Bergtheim (DE); Patrick Simeth, Deggendorf OT Deggenau (DE); Rico Schippan, Rehau (DE); Dominik Linster, Boppard (DE); Kevin Wild, Erlbach (DE)

(21) Appl. No.: 16/341,306

(22) PCT Filed: Nov. 2, 2017
(86) PCT No.: PCT/EP17/01270

§ 371 Date: Apr. 11, 2019

(30) Foreign Application Priority Data
Nov. 2, 2016 (DE) 102016120893.0

(51) Int. Cl. B29C 70/44; B29C 70/86; F17C 1/06

(52) U.S. Cl. CPC B29C 70/443; B29L 2031/7156; F17C 1/06; B29C 70/86

(57) ABSTRACT

The invention relates to a method for producing a pressure accumulator (1), in particular for accumulating hydrogen in motor vehicles, wherein first of all an inner liner (3) of the pressure reservoir (1) is produced, preferably by means of a plastic blow molding process, wherein subsequently the inner liner (3) is provided, preferably braided, on the outside with a multi-ply reinforcing layer (9) including reinforcement fibers (8), and wherein the reinforcing layer (9) is then impregnated with a resin, preferably an epoxy resin, which, after curing, fixes the position of the reinforcement fibers (8) in the reinforcing layer (9). According to the invention the impregnation takes place from the contact region (K) of the outer surface of the inner liner (3) with the reinforcing layer (9) to the outer region of the reinforcing layer (9).

The invention relates to a method for producing a pressure accumulator, in particular for storage of hydrogen in motor vehicles,
wherein initially, preferably by means of a plastic blow molding method, an inliner of the pressure accumulator is produced,
wherein subsequently the inliner is provided, preferably braided, on the outside with a multi-layered reinforcing layer having reinforcement fibers, and
wherein after this the reinforcing layer is impregnated with a resin, preferably an epoxy resin, which after its curing fixes the position of the reinforcement fibers in the reinforcing layer.

Such a method is known, for example, from WO 2015/078555 A1. Pressure accumulators for storage of hydrogen in motor vehicles must, on the one hand, provide an as large as possible storage volume in a predetermined installation space and, on the other hand, have a low weight, in order to ensure a low fuel consumption. In addition, there is of course the need to be able to produce such pressure accumulators at competitive costs.

Relative to hydrogen pressure accumulators, for example, made of metal, pressure accumulators with an inliner made of plastic are characterized by a low weight. However, in order to withstand the high pressure required in the storage of a sufficiently large amount of hydrogen, usually approx. 700 bar, such plastic inliners must regularly be provided with a reinforcing layer. This is applied to the inliner, for example, in a braiding or also winding process. One objective in the production of the reinforcing layer is to be able to load the individual reinforcement fibers of the reinforcing layer, which can be designed, for example, as carbon and/or glass fibers, as uniformly as possible during operation. In this way it is ensured that the mechanical loadability of the individual reinforcement fibers is utilized as well as possible. After application of the reinforcing layer the pressure accumulator located in the production process (also called preform) is for this purpose introduced into a suitable tool and is impregnated with a resin, preferably an epoxy resin, which after its curing fixes the position of the reinforcement fibers in the reinforcing layer. The resin can be introduced into the reinforcing layer by means of a vacuum-assisted RTM method (Resin-Transfer-Molding). In order to avoid a collapse of the inliner during the impregnation, the so-called infiltration, the pressure accumulator is subjected to an internal overpressure, so that it abuts against the inner surface of the tool under pressing action. To completely cure the resin the inliner is unloaded and the pressure accumulator is removed from the tool.

It is ensured by the cured resin, that the individual reinforcing fibers of the reinforcing layer cannot or can only slightly be moved during the operation, therefore, the reinforcing layer remains in an, as it were, frozen state. Thus, a permanently high performance of the reinforcing layer is ensured during the possibly decades-long use of the pressure accumulator. Usually the introduction of the resin takes place from one side of the tool, i.e., the resin is introduced into the tool cavity from one or several gate locations and, seen from there, should impregnate the entire reinforcing layer as uniformly as possible. This procedure is indeed unproblematic in the case of thin-walled components, but not in the case of the reinforcement of a hollow body of the type in question. As already explained, the inliner is subjected to an internal overpressure during the resin impregnation of the reinforcing layer. However, this leads especially in the contact region of the outer surface of the inliner with the reinforcing layer to the reinforcement fibers located there being compressed very strongly and thus the intermediate spaces between them being reduced. This makes the impregnation of these inner areas of the reinforcing layer more difficult. This effect intensifies with the increasing number of reinforcement fiber layers. Thus, for example, in the case of a pressure accumulator suitable for the storage of hydrogen at several hundred bar as a rule at least 30 reinforcement fiber layers are provided. If the flow front of the resin now penetrates from outside to inside, layers not yet impregnated are further compressed by the resin pressure. As a result, in practice air pockets or unimpregnated areas remain at different locations, in particular in the inner region of the reinforcing layer, which lead locally to a lack of fixation of the reinforcing layer by the resin. This significantly affects the performance of the reinforcing layer.

Against this background the problem addressed by the invention is to indicate a method with the features described at the outset, which makes possible a uniform impregnation of the reinforcing layer with the resin.

According to the present invention the problem is solved in that the impregnation takes place beginning from the contact region of the outer surface of the inliner with the reinforcing layer towards the outer region of the reinforcing layer. According to the present invention the usual method of starting the impregnation on the outer surface of the reinforcing layer is therefore departed from. Through the resin impregnation of the reinforcing layer from the inside to the outside, for example, through the vacuum-assisted RTM method, it is ensured according to the present invention, that in particular the reinforcement fibers located in the mentioned contact region are also impregnated uniformly with the resin, thus the intermediate spaces between the fibers are closed by the resin and accordingly after the resin curing the fibers are precisely fixed relative to one another. This contact region is subjected to the resin by the method according to the present invention during the impregnation from the beginning and permanently, so that even the small intermediate spaces between the reinforcement fibers can be sufficiently, preferably completely, filled with resin in this region. This leads overall to a significantly improved performance of the reinforcing layer, since a fixation of the reinforcing fibers to each other by the resin is ensured homogeneously over the entire cross-sectional area of the reinforcing layer.

Expediently, to assist the flow process of the resin in the mentioned contact region the outer surface of the inliner is provided with several, for example, at least 8, in particular, at least 16, web-shaped recesses. The recesses are preferably arranged distributed uniformly over the circumference of the inliner. Expediently, they run at least substantially parallel to the axis of rotation of the pressure accumulator in a cylindrical area of the inliner. The recesses can have a depth of 0.2-10 mm, for example, 0.5-5 mm. The width of the recesses is expediently 1-20 mm, for example, 2-10 mm. Through the recesses the flow of the resin is facilitated along the outer surface of the inliner in the contact region with the reinforcing layer. Expediently, the recesses extend into the pole regions of the inliner, which are curved in a side view. Thus, in the pole region the assistance of the flow process of the resin along the outer surface of the inliner is also ensured.

Preferably the inliner is provided in at least one pole region with a pole cap attachment, into which at least one flow channel is introduced, through which the resin is conduced to the mentioned contact region. This pole cap attachment can, for example, be a fiber supply cap elucidated later in detail and/or a connecting piece, in particular, a so-called “boss”. A connecting piece of the pressure accumulator referred to as a boss is provided with an opening, which serves for filling or for dispensing hydrogen. The pole cap provided on the opposite end of the pressure accumulator can also have a so-called blind boss (preferably without an opening), which serves only for mounting the pressure accumulator in the vehicle.

By means of the flow channel it is initially possible to selectively guide the resin to the contact region via the correspondingly equipped pole cap attachment and accordingly to begin there with the resin impregnation of the reinforcing layer. Expediently, the pole cap attachment has several, for example, at least four, in particular, ten flow channels, which are preferably uniformly distributed over the circumference. Alternatively to the uniform distribution over the circumference, the flow channels can also be distributed combined in groups on the circumference, i.e., for example, after one group of flow channels uniformly spaced apart in the circumferential direction (=flow channel group) a circumferential section free of flow channels follows, to which in turn a flow channel group is connected. The circumferential section free of flow channels can, for example, serve for arranging stiffening elements, in particular stiffening ribs, of the pole cap attachment.

Expediently, the inliner is made of a stiff, only slightly elastically deforming plastic, for example, polyamide. This has the advantage that when the inliner is subjected to an internal overpressure the above-described compression of the reinforcement fibers is less strongly pronounced in particular in the contact region than in the case of an inliner, which is strongly deformed in the case of an internal pressurization.

As already explained, the pressure accumulator located in the production process can be introduced into a tool surrounding the reinforcing layer after application of the reinforcing layer for carrying out the resin impregnation. This tool is expediently provided with at least one suction connection piece, through which during the impregnation a vacuum is maintained within the tool. The impregnation preferably takes place by means of the vacuum-assisted RTM method. As also already explained, the inliner can expediently be subjected to an internal overpressure during the impregnation, so that the pressure accumulator under pressing action abuts against the inner surface of the tool. Preferably, the reinforcing layer is frozen by the curing of the resin in the state expanded by the internal overpressure.

It is also within the scope of the invention that the reinforcing layer is surrounded by a coating, preferably a fleece, before being introduced into the tool, which compensates for tolerances to the inner surface of the tool. As a result, a flow of the resin in a gap between the reinforcing layer and the inner tool surface, prevents a so-called direct overshoot of resin into this annular gap. Such a coating furthermore has the advantage that during the impregnation with resin it remains permanently on the pressure accumulator and can thus serve as an outer protective layer of the pressure accumulator. It is furthermore within the scope of the invention in particular that in at least one pole region of the inliner at least one sealing ring arranged between the reinforcing layer and tool is pressed against the inner surface of the tool, which during the impregnation directs the resin towards the contact region. Through this measure it is also prevented that the resin migrates prematurely into the outer area of the reinforcing layer, before a complete impregnation of the inner area, in particular in the contact region, exists. This sealing ring can remain permanently on the pressure accumulator after completion of the production process.

Furthermore, the subject matter of the invention is a pressure accumulator, which was produced with one of the above-described methods according to the present invention. As already explained, the pressure accumulator produced according to the present invention serves for storing hydrogen in motor vehicles, for example, at 500 bar overpressure or more. Other cases of application, however, are not thereby excluded.

The invention is elucidated in detail below by means of a drawing representative of only one embodiment. Schematically

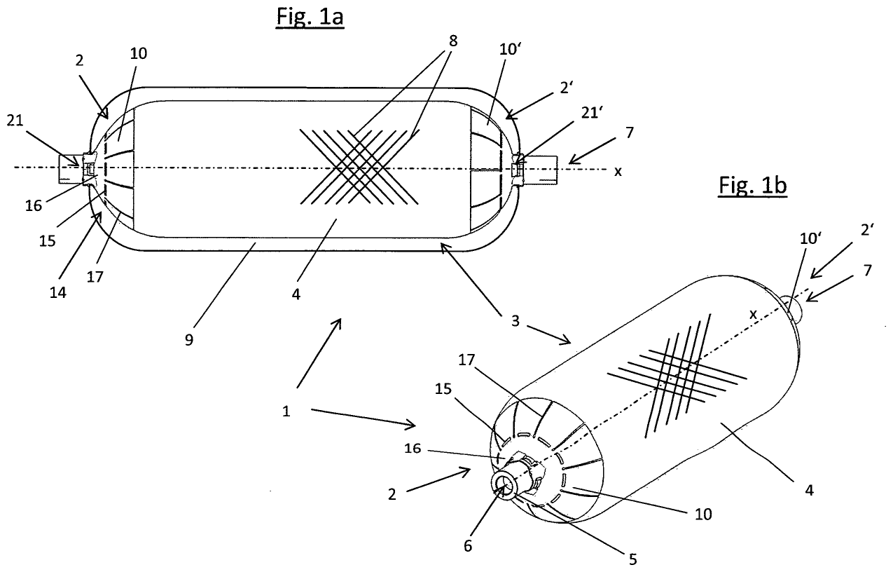

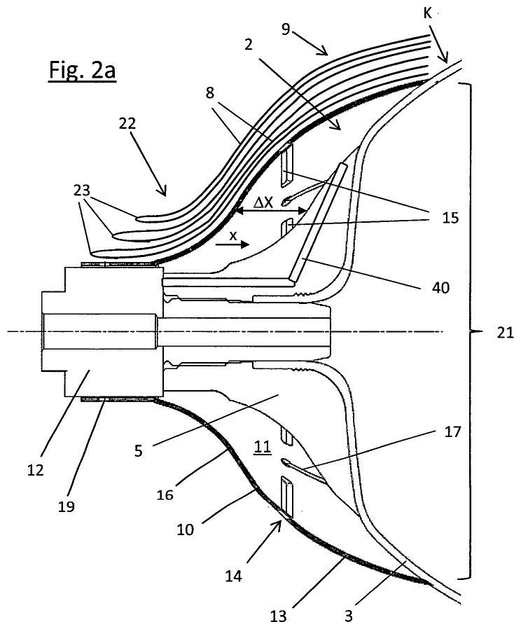

FIGS. 1a, b: show a pressure accumulator produced according to the present invention in the finished state;

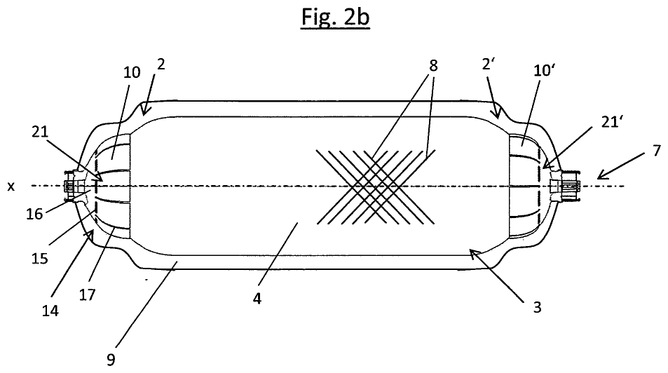

FIGS. 2a, b: show the pressure accumulator shown in FIGS. 1a, b during the application of reinforcement fibers in a partial cross-sectional view or in a side view;

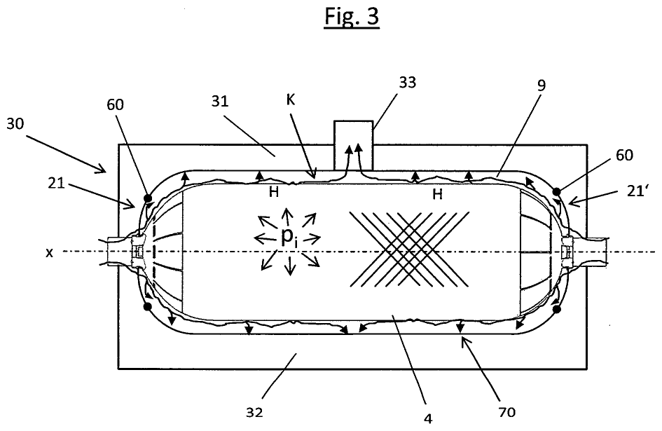

FIG. 3: shows the pressure accumulator shown in FIGS. 1a, b during the impregnation according to the present invention of the reinforcement fibers with a resin;

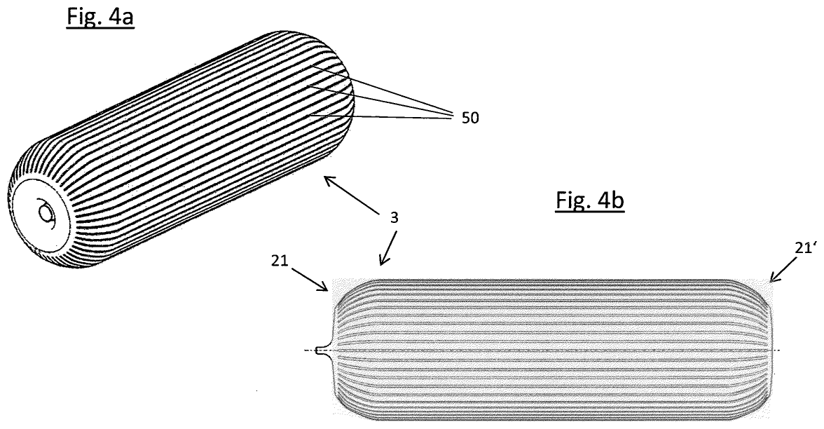

FIGS. 4a,b: show the inliner shown schematically in FIGS. 1-3 in a three-dimensional individual representation as well as in an individual side view;

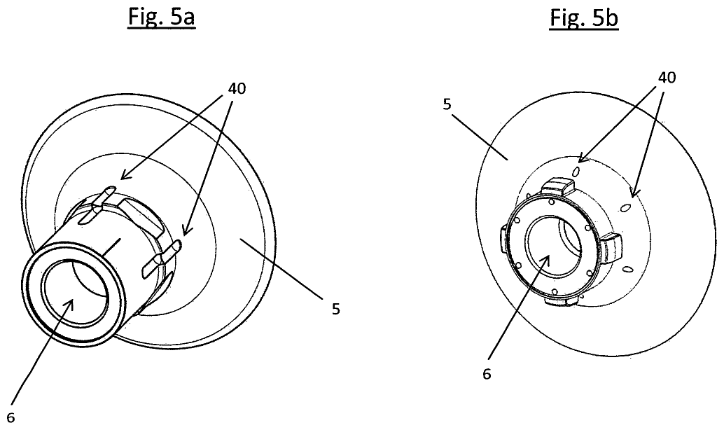

FIGS. 5a,b: show two different embodiments of a boss already depicted in principle in FIGS. 1-3, which serves for the refueling or for the removal of hydrogen, and

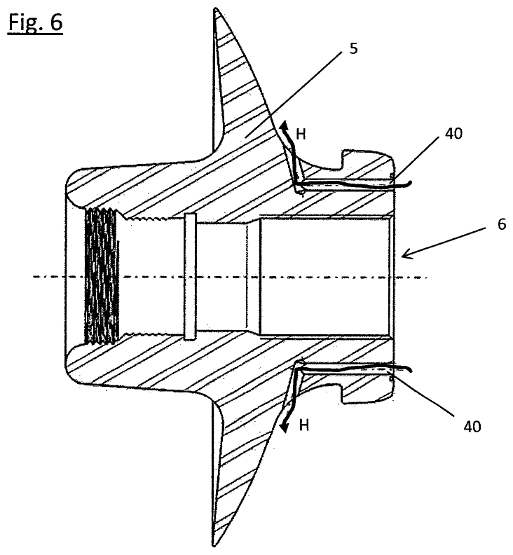

FIG. 6: shows the boss depicted in FIG. 5b in a cross-sectional representation.

FIGS. 1a, b show a pressure accumulator 1 for the storage of hydrogen in a motor vehicle. The pressure accumulator 1 possesses an inliner 3 having two pole caps 2, 2′, produced from plastic with a cylindrical center section 4. The two pole caps 2, 2′ are integrally formed on the end side of this center section 4. The pole cap 2 of the pressure accumulator 1 additionally comprises a connecting piece 5 also referred to as boss 5 with an opening 6 for the filling or for the dispensing of hydrogen. The pole cape 2′ provided on the opposite end of the pressure accumulator 1 additionally comprises in the embodiment a so-called blind boss 7, therefore a boss without an opening, which only serves for mounting the pressure accumulator 1 in the vehicle. On the inliner 3 a braided, multi-layered reinforcing layer 9 having a reinforcement fiber 8 is applied on the outside. The reinforcement fibers 8 are designed in the embodiment as carbon fibers and in FIGS. 1a, b are only indicated individually for the purpose if improving the clarity. Likewise, to improve the understanding, the multi-layered reinforcing layer 9 having, for example, more than 30 reinforcement fiber layers is only schematically depicted in FIG. 1a. It can be seen from FIGS. 1a, b, that between the pole caps 2, 2′ and the reinforcing layer 9 in each case its so-called fiber supply cap 10, 10′ is provided, which during the application of the reinforcement fibers 8 on the inliner ensures a fiber supply 22 (see FIG. 2a) for the inner layers of the reinforcing layer 9. It can be seen from FIG. 2a, that during the application of the reinforcing layer 9 supply cap 10 and the pole cap 2 jointly form a cavity 11 and the fiber supply cap 10 is fixed by a fixation device 12 in a corresponding position. Analogously the fiber supply cap 10′ and the pole cap 2′ are also positioned relative to each other (see FIG. 2b). The fiber supply caps 10, 10′ are in each case designed thin-walled with an average wall thickness <5 mm and produced from plastic. FIGS. 1a and b show, that—in contrast to FIGS. 2a, b—in the finished state of the pressure accumulator 1 the design of the fiber supply caps 10, 10′ is adapted to the outer contour of the pole caps 2, 2′. For this purpose, the fiber supply caps 10, 10′ have an elastic deformability in the outer area 13 (FIG. 2a), which makes possible the adaptation to the outer contour of the pole caps 2, 2′.

The method according to the present invention for producing the pressure accumulator 1 is now elucidated by means of FIGS. 2a, 2b and 3. Initially, the inliner 3 (see FIGS. 4a, 4b) of the pressure accumulator 1 constructed from a cylindrical center section 4 with end-side pole caps 2, 2′ is produced by means of a plastic blow-molding process. In each case a pole cap attachment in the form of a boss 5 or a blind boss 7, preferably in each case produced from metal, is mounted on the pole caps 2, 2′, which were mounted after the blow-molding process (see FIGS. 1a, 1b). Subsequently, the inliner 3 is braided on the outside with multi-layered reinforcing layer 9 having reinforcement fibers 8. On the two pole caps 2, 2′ before the application of the reinforcement fibers 8 further pole cap attachments in the form in each case of a fiber supply cap 10, 10′ are mounted, the outer surface of which is spaced apart from the pole region 21, 21′ of the corresponding pole cap 2, 2′ (see FIG. 2b). During the application of the reinforcing layers 9 the reinforcement fibers 8 are applied to the body of the inliner 3 and in the pole regions 21, 21′ correspondingly to the outer surface of the fiber supply caps 10, 10′. Due to the distance between the outer surface of the fiber supply caps 10, 10′ and the pole region 21, 21′ of the pole caps 2, 2′ the inner layers of the reinforcing layer 9 formed from the reinforcement fibers 8 in the pole regions 21, 21′ are provided with a fiber supply 22 (FIG. 2a). The fiber supply cap 10 and the pole cap 2 with the boss 5 jointly form a hollow space 11 during the application of the reinforcing layer 9. The fiber supply cap 10 is fixed when the reinforcing layer 9 is applied by a fixation device 12, which ensures the spacing of the fiber supply cap 10 from the pole region 21 during this step.

After applying the complete reinforcing layer 9, the pressure accumulator 1 located in the production process is introduced into a tool 30 depicted in FIG. 3, completely surrounding the reinforcing layer 9, adapted to the outer contour of the reinforcing layer 9, having two tool halves 31, 32, which tool serves for the impregnation of the reinforcing layer with a resin H in the vacuum-assisted RTM process. The fixation device 12 is released and the inliner is subjected to an internal overpressure pᵢ. In this connection, the reinforcing layer 9 is applied under pressing action to the inner surface of the two tool halves 31, 32 of the tool 30. Due to the tension of the applied reinforcement fibers 8 the fiber supply cap 10 is displaced to the pole region 21 in the direction of the arrow X (FIG. 2a) and in this connection the fiber supply 22 is released. When the fiber supply 22 is released the fiber supply caps 10, 10′ are adapted to the—in each case partially formed from the boss 5 or blind boss 7—outer contour of the pole caps 2, 2′ (see also FIGS. 1a, b). For this purpose, the outer region 13 of the fiber supply caps 10, 10′ is formed elastically. In the embodiment the transition from the rigid inner region 16 to the elastic outer region of the fiber supply cap 10 corresponds in respect to the outer surface of the pole cap substantially to the transition from the boss to the blow-molded part of the inliner. I.e., the rigid inner region 16 of the fiber supply cap is applied to the surface of the boss 5, whereas the outer region 13 under an elastic deformation of a circumferential material weakening 14 of the fiber supply caps 10, 10′ adapts to the adjacent surface contour of the blow-molded part of the inliner 3. The circumferential material weakening 14 serves during the adaptation of the fiber supply cap 10, 10′ to the outer contour of the pole cap 2 or 2′ as a rotary joint for the outer region 13 of the fiber supply cap 10, 10′. The material weakening 14 is formed in the embodiment from several circumferential slots 15. The circumferential slots 15 are distributed uniformly over the circumference. They penetrate completely through the material of the fiber supply cap 10. The circumferential slots 15 can be provided with spacers facing towards the inliner 3 (not shown in detail), which prevent a planar application of the fiber supply cap 10, 10′ to the boss 5 and thus facilitate the melt flow of the resin H under the fiber supply cap 10, 10′. The spacers can be designed as lugs integrally formed on the boundary of the circumferential slots 15.

Furthermore, it can be seen by means of FIG. 2a, that before the release of the fiber supply 22 the individual layers of the reinforcing layer 9 were applied in such a manner that the reversal points 23 arising on the fiber supply cap 10 are displaced axially in the direction of the inliner 3 with increasing layer thickness at the transition between the individual layers. The fiber supply cap 10 itself ensures a predetermined distance Δ X to the pole cap 2, which significantly determines the size of the fiber supply 22. By means of the fiber supply caps 10, 10′ the fiber lengths can be provided and positioned precisely in all layers. After the fiber supply caps 10, 10′ have been applied to the pole caps 2, 2′, the reinforcing layer 9 is impregnated in the tool 30 with the resin H, in order to fill up the free spaces located between the individual reinforcement fibers 8 and thus to further strengthen the strength of the reinforcing layer 9. According to the present invention, the impregnation now begins in the form of an injection beginning from the contact region K of the outer surface of the inliner 3 with a reinforcing layer 9 towards the outer region of the reinforcing layer 9. This is depicted in FIG. 3 by the arrows depicting the flow of the resin H. The arrows show, that the resin H flows during the impregnation of the reinforcing layer 9 initially along the contact region K and migrates outwards from there with a radial flow component. For this purpose, the resin H is initially introduced through flow channels 40 provided both in the boss 5 as well as in the blind boss 87, in each case distributed uniformly over the circumference, through which flow channels the resin H is directed to the contact region K. In the pole regions 21, 21′, in this connection the flow front of the resin H as a rule reaches the outer region of the reinforcing layer 9 earlier than this is the case in the region of the cylindrical center section 4 of the inliner 3. The impregnation of the reinforcing layer 9 in the contact region K is furthermore assisted in that the outer surface of the inliner 3 during the blow-molding process was provided with web-shaped recesses 50 (FIGS. 4a,b), which are arranged distributed uniformly over the circumference of the inliner 3. In the cylindrical region of the inliner 3 the recesses 50 run parallel to the axis of rotation x of the pressure accumulator 1. It can be seen by means of FIGS. 4a, b, that the recesses 50 extend into the pole regions 21, 21′ of the inliner, which are curved in a side view. The inliner 3 is produced from polyamide and therefore is deformed elastically only slightly due to the internal overpressure pᵢ. The tool 30 is provided with a suction connection piece 33, by means of which during the infiltration within the tool a vacuum is maintained. Due to the internal overpressure pᵢ in the inliner 3 the pressure accumulator 1 abuts against the inner surface of the tool 30 under pressing action. When the resin H is cured the reinforcing layer 9 is frozen in the state slightly expanded by the internal overpressure pᵢ. Before being introduced into the tool 30 the reinforcing layer 9 was surrounded with a fleece 70, which compensates for tolerances to the inner surface of the two tool halves 31, 32 of the tool 30 and thus prevents a direct overshoot of resin H in this region. By means of FIG. 3 it can furthermore be seen, that when the two tool halves 31, 32 are joined together in two pole regions 21, 21′ of the inliner 3 in each case a sealing ring 60 is pressed against the inner surface of the tool 30, which during the subsequent impregnation of the resin H direct the resin towards the contact region K.

The above-described method according to the present invention makes possible a very uniform impregnation of the reinforcing layer 9 with the resin H, so that in particular also the intermediate spaces between the individual reinforcement fibers 8 in the contact region K can be filled with resin. Thus, the individual reinforcement fibers 8 are fixed very well relative to each other within the entire reinforcing layer 9, whereby a high performance of the reinforcing layer 9 is ensured.

1.-12. (canceled)

13. A method for producing a pressure accumulator for storage of hydrogen in motor vehicles, comprising the steps of:
producing an inliner of the pressure accumulator;
providing an outside of the inliner with a multi-layered reinforcing layer having reinforcement fibers;
impregnating the reinforcing layer with a resin which, after curing, fixes a position of the reinforcement fibers in the reinforcing layer;
wherein the impregnation takes place beginning from a contact region of an outer surface of the inliner with the reinforcing layer towards an outer region of the reinforcing layer.

14. The method according to claim 13, wherein, in order to assist the flow process of the resin in the contact region, the outer surface of the inliner is provided with web-shaped recesses, which are uniformly distributed over a circumference of the inliner.

15. The method according to claim 14, wherein the recesses extend into pole regions of the inliner, which are curved in a side view.

16. The method according to claim 13, wherein the inliner is provided in at least one pole region with a pole cap attachment, in which at least one flow channel is introduced, through which the resin is directed to the contact region.

17. The method according to claim 13, wherein the inliner is produced from polyamide.

18. The method according to claim 13, wherein the pressure accumulator is introduced after application of the reinforcing layer for implementing the resin impregnation into a tool surrounding the reinforcing layer.

19. The method according to claim 18, wherein the tool is provided with a suction connection piece, through which, during the impregnation, a vacuum is maintained within the tool.

20. The method according to claim 18, wherein the inliner is subjected to an internal overpressure (pᵢ) during the impregnation, so that the pressure accumulator abuts against an inner surface of the tool under pressing action.

21. The method according to claim 20, wherein the reinforcing layer is frozen by the curing of the resin in a state expanded by the internal overpressure (pᵢ).

22. The method according to claim 18, wherein the reinforcing layer is surrounded by a coating before being introduced into the tool so as to compensate for tolerances to the inner surface of the tool.

23. The method according to claim 18, wherein, in at least one pole region of the inliner, at least one sealing ring arranged between the reinforcing layer and the tool is pressed against the inner surface of the tool so as to direct the resin towards the contact region during the impregnation.

24. A pressure accumulator produced according to a method according to claim 13.
